(19) United States
(12) Patent Application Publication
(10) Pub. No.: US 2023/0127591 A1
(43) Pub. Date: Apr. 27, 2023

(54) Ratchet Wrench Drill Attachment

(71) Applicant: Justin Byler, Cortland, OH (US)

(72) Inventor: Justin Byler, Cortland, OH (US)

(21) Appl. No.: 17/507,375

(22) Filed: Oct. 21, 2021

(51) Int. Cl. B25B 13/46

(52) U.S. Cl. CPC B25B 13/465; B25B 13/467

(57) ABSTRACT

The present invention provides a ratchet wrench attachment for a drill. The device includes an elongated body including a ratchet head disposed on one end therof, wherein the ratchet head is removably securable thereto. The ratchet head includes an interior gear, which is affixed to a tube having a central aperture. A removable drive shaft-secured to the central aperture, and thus connected to the gear—-extends outward from the first end of the elongated body. The drive shaft extends through the elongated body beyond a periphery the opposite end of the elongated body. In one embodiment, the drive shaft comprises a hexagonal cross-section, whereby the drive shaft may be secured within the chuck of a power drill. The power drill causes the drive shaft to rotate, which, in turn, causes the ratchet head to rotate in a desired direction. The device can be used with any ordinary power drill.

### BACKGROUND

Reaching into tight spaces to tighten or loosen nuts and bolts can be difficult. People may be unable to firmly secure or completely remove the nut or bolt with a hand wrench. Manually turning the nut or bolt may be difficult and lead to individuals injuring themselves due to scraping fingers against an abrasive surface. People often need a number of ratchet heads or wrenches to remove or tighten nuts and bolts, which can be bulky, time-consuming, and inconvenient. Accordingly, a ratchet device that is configured to enable a user to remove or tighten a nut or bolt is desired.

### SUMMARY OF THE INVENTION

The main purpose of the ratchet wrench drill attachment is to provide users with a ratchet wrench that easily attaches onto an impact or drill to allow for a more efficient wrenching operation. Tightening and loosening nuts on threaded rods and difficult-to-access areas is a tedious task for many individuals. This challenging operation is incredibly time consuming, tiring, and inconvenient considering users must continually remove and replace the wrench to tighten and loosen the bolts in tight spaces. This ratchet wrench drill attachment enables workers to easily access nuts in problematic areas to allow for improved functionality.

Expanding on the initial design of an average wrench, the ratchet wrench drill attachment introduces a novel interchangeable ratchet wrench with a drill attachment. With just a simple pull of a trigger, users will be able to tighten or remove nuts and bolts, in a timely and nonlaborious manner.

To further enhance functionality, the innovative release button enables users to easily detach the wrench head from the attachment and switch to the wrench head size that is needed. In return, workers can apply and remove fasteners without having to continually replace their wrench. The ratchet wrench drill attachment ensures a fully operational wrench that simplifies the otherwise exhausting wrenching operation and eliminates the need for users to carry an entire wrench set of different sizes to complete their tasks. This innovative, top quality product will benefit workers in many industries and may prove to be essential in the hardware industry.

### BRIEF DESCRIPTION OF THE DRAWINGS

FIG. 1 shows a perspective view of an embodiment of the ratchet wrench attachment for a drill while in use in accordance with an embodiment of the present disclosure.

FIG. 2 shows the motion of a nut being tightened on a threaded rod in accordance with an embodiment of the present disclosure.

FIG. 3 shows a perspective view of the ratchet wrench attachment for a drill in use in accordance with an embodiment of the present disclosure.

FIG. 4 shows the major torque transfer ring and the minor torque transfer ring and the drill rod engaged with major torque transfer ring in accordance with an embodiment of the present disclosure.

FIG. 5 shows the side view engagement of the torque transfer rings with the drill rod in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

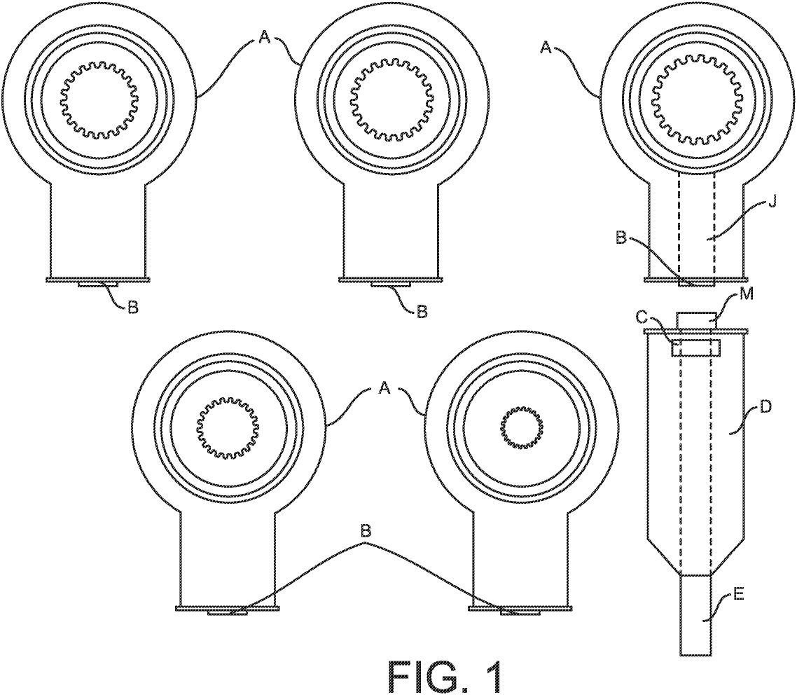

FIG. 1 shows a perspective view of an embodiment of the ratchet wrench attachment for a drill while in use in accordance with an embodiment of the present disclosure.

Reference A depicts the interchangable ratchet wrench. Reference B depicts the female side to insert the drill rod. Reference C depicts the release button. Reference D depicts the drill attachment. Reference E depicts the drill rod. Reference F depicts the threaded rod. Reference G depicts the hex nut. Also, the male side M of the coupling engages with the female side B so that the drill rod extension J may engage with the torque transfer ring in the ratchet wrench head A.

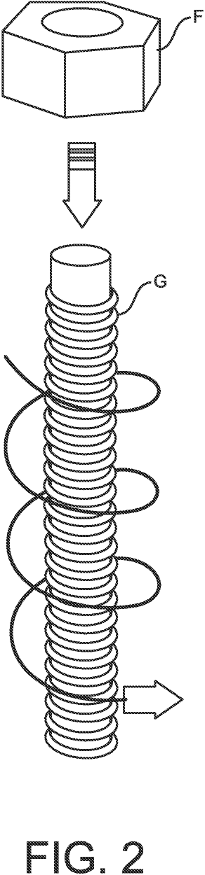

FIG. 2 shows the motion of a nut being tightened on a threaded rod in accordance with an embodiment of the present disclosure.

Reference A depicts the interchangable ratchet wrench. Reference B depicts the female side to insert the drill rod. Reference C depicts the release button. Reference D depicts the drill attachment. Reference E depicts the drill rod. Reference F depicts the threaded rod. Reference G depicts the hex nut.

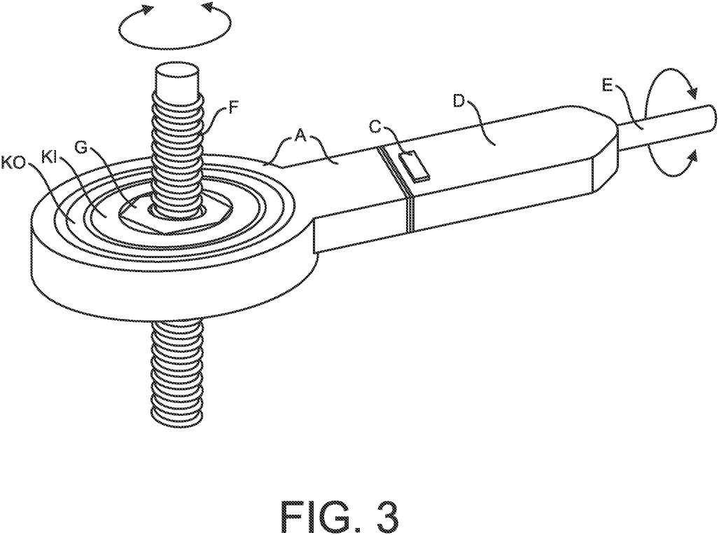

FIG. 3 shows a perspective view of the ratchet wrench attachment for a drill in use in accordance with an embodiment of the present disclosure.

Reference A depicts the interchangable ratchet wrench. Reference B depicts the female side to insert the drill rod. Reference C depicts the release button. Reference D depicts the drill attachment. Reference E depicts the drill rod. Reference F depicts the threaded rod. Reference G depicts the hex nut.

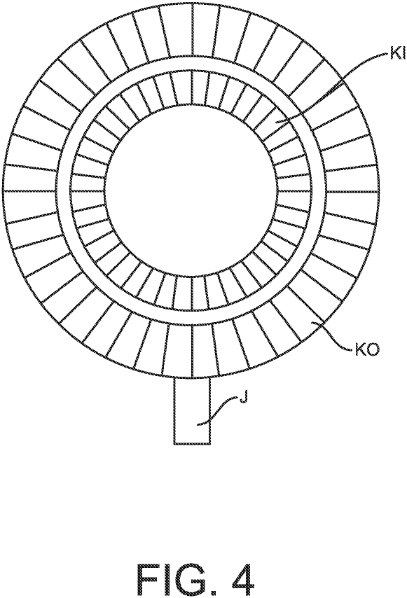

FIG. 4 shows the major torque transfer ring KO and the minor torque transfer ring KI and the drill rod J engaged with major torque transfer ring KO in accordance with an embodiment of the present disclosure. The torque transfer ring KI offers a finer torque to turn of the drill rod J than KO which is a course torque to turn of the drill rod J. Which torque transfer ring is engaged with the drill rod J depends on a lateral force parallel with a length of the drill rod J. The gear teeth on either ring are hidden from sight to protect an operator.

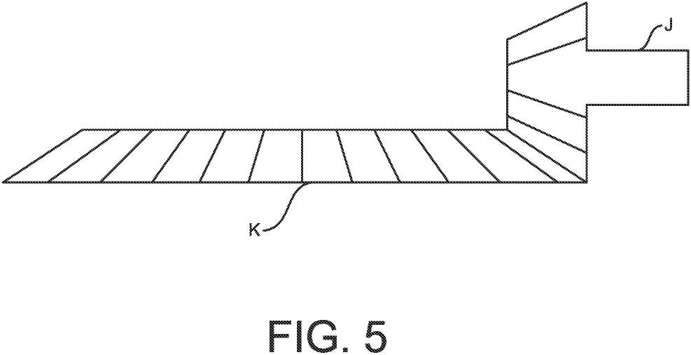

FIG. 5 shows the side view engagement of the torque transfer rings with the drill rod in accordance with an embodiment of the present disclosure.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A ratchet wrench comprising:
an interchangeable ratchet head having a torque transfer joint therein for transferring a torque force into a right angle from its original movement, wherein the torque transfer joint comprises a major and a minor ring; and
a drill attachment configured to releasably mate with one of the major and the minor ring of the interchangeable ratchet head via a drill rod and comprising a coupling end and also a drill rod end.

2. The ratchet wrench of claim 1 wherein the interchangeable ratchet head comprises a plurality of teeth to receive a nut of a predetermined size.

3. The ratchet wrench of claim 1, wherein the interchangeable ratchet head comprises a female end coupling to receive the drill attachment via the female lend coupling.

4. The ratchet wrench of claim 1, wherein the drill attachment further comprises a release button configured to release a coupling of the interchangeable ratchet head thereto.

5. The ratchet wrench of claim 1, wherein the drill attachment coupling end further comprises a male end to receive the interchangeable ratchet head via the male end.

6. The ratchet wrench of claim 1, wherein the drill rod end comprises a drill rod configured to deliver the torque force from a drill rod to the coupling end.

7. The ratchet wrench of claim 1, wherein the torque transfer joint comprises a threaded tip configured to engage the threads of an angularly threaded nut.

8. The ratchet wrench of claim 1 wherein the interchangeable ratchet head comprises a plurality of teeth circumferentially configured to receive a nut of a predetermined size.

9. The ratchet wrench of claim 1, wherein the interchangeable ratchet head comprises a plurality of teeth arranged on an inside diameter of a ring configured to rotate within an outer housing.

10. The ratchet wrench of claim 1, wherein the major ring comprises a diameter larger than a diameter of the minor ring.

11. The ratchet wrench of claim 1, wherein the major ring and the minor ring both comprise gear teeth on a side thereof configured to engage with gear teeth on the drill rod.

12. The ratchet wrench of claim 1, wherein the drill rod engages with one of the major and the minor ring based on a lateral force parallel with a length of the drill rod.
